(19) United States
(12) Patent Application Publication
(10) Pub. No.: US 2006/0232130 A1
(43) Pub. Date: Oct. 19, 2006

(54) Traction apparatus for wheeled vehicles

(76) Inventor: Christian Hansen, Oakland, CA (US)

Correspondence Address: THOMAS R. LAMPE;BIELEN, LAMPE & THOEMING, 1390 WILLOW PASS ROAD, SUITE 1020, CONCORD, CA, 94520, US

(21) Appl. No.: 11/110,595

(22) Filed: Apr. 19, 2005

(51) Int. Cl. B62D 55/12

(52) U.S. Cl. 305/200

(57) ABSTRACT

Traction apparatus extends between the front and rear tires of a land vehicle to form an endless track including a plurality of rigid traction members and connectors including multi-link chains extending between and flexibly interconnecting the traction members.

### TECHNICAL FIELD

This invention relates to apparatus for use with a skid steer loader or other land vehicle having front and rear tires to improve traction of the land vehicle.

### BACKGROUND OF THE INVENTION

It is well known generally to employ removable, flexible track belts wrapped around front and rear vehicle tires to provide improved traction. However, known prior art arrangements of this nature have a number of drawbacks. Prior art devices are often difficult to install and remove, at least partially due to their heavy weight and employment of rigid links extending between the traction members or feet thereof. These design and other structural limitations make it difficult to effect repairs and also to adjust the operating lengths of the apparatus track, as is sometimes necessary or desirable.

The following patent documents are believed to be representative of the current state of the art in this field: U.S. Pat. No. 4,099,794, issued Jul. 11, 1978, U.S. Pat. No. 5,988,776, issued Nov. 23, 1999, U.S. Pat. No. 5,284,387, issued Feb. 8, 1994, U.S. Pat. No. 2,455,307, issued Nov. 30, 1948, U.S. Pat. No. 4,089,565, issued May 16, 1978, U.S. Pat. No. 6,464,309, issued Oct. 15, 2002, U.S. Pat. No. 3,133,767, issued May 19, 1964, U.S. Pat. No. 2,973,995, issued Mar. 7, 1961, U.S. Pat. No. 5,641,213, issued Jun. 24, 1997, U.S. Pat. No. 2,670,996, issued Mar. 2, 1954, U.S. Design Patent No. D298,018, issued Oct. 11, 1988 and European Patent No. 129493.

There are a number of currently commercially available devices for retrofitting to vehicles to provide a track between front and rear tires. Known representative devices are the Grouser and Loegering track attachments made available by Bobcat Company, West Fargo, N. Dak., and identified by reference numbers 553-963 in Bobcat Catalog No. B-1595 and employing rigid links. O'Reilly Machines and Manufacturing of Goodhue, Minn. makes available SkidTrax skid steer tracks incorporating continuous track chains.

The above-identified prior art does not teach or suggest the advantageous structural elements and cooperative relationships disclosed herein.

### DISCLOSURE OF INVENTION

The present invention relates to traction apparatus for improving the traction of a land vehicle which is characterized by its relatively light weight and by its ability to be easily installed on tires of a skid steer loader or other land vehicle or removed therefrom, for example for repair, adjustment or replacement purposes. Furthermore, the traction apparatus can be shortened or lengthened by removing or adding traction members and/or other components or replacing some or all of the traction members with traction members of different types and sizes, depending upon the conditions encountered.

The traction apparatus of the present invention is extendable between front and rear tires of a land vehicle to improve traction of the land vehicle, the traction apparatus when extending between the front and rear tires forming an endless track having an upper track portion and a lower track portion interconnected by end track portions engaging and partially surrounding the front and rear tires.

The traction apparatus includes a plurality of rigid traction members, adjacent traction members of the plurality of rigid traction members each including a traction member base and spaced traction member sides extending outwardly from spaced locations on the traction member base to form a generally U-shaped configuration and define a tire receiving recess.

The traction apparatus also incorporates connectors including multi-link chains extending between and flexibly interconnecting adjacent traction members.

Other features, advantages and objects of the present invention will become apparent with reference to the following description and accompanying drawings.

### BRIEF DESCRIPTION OF DRAWINGS

FIG. 1 illustrates a preferred embodiment of traction apparatus constructed in accordance with the teachings of the present invention extending between front and rear tires of a land vehicle;

FIG. 2 is an enlarged, perspective view of a segment of the apparatus illustrating one complete traction member and parts of adjoining traction members connected thereto by multi-link chains;

FIG. 3 is a perspective view of the traction member separated from the rest of the traction apparatus and inverted from the position shown in FIG. 2;

FIG. 4 is a view similar to FIG. 3, but illustrating an alternative form of traction member;

FIG. 5 is a view similar to FIGS. 3 and 4, but illustrating another alternative form of traction member;

FIG. 6 is an exploded, perspective view of a portion of the traction member as shown in FIGS. 1-3 with multi-link chains prior to attachment thereto by connectors;

FIG. 7 is a perspective view showing portions of two adjacent traction members connected together by a multi-link chain;

FIG. 8 is an end view depicting a traction member in two alternative positions, one illustrated by solid lines and the other illustrated by broken lines, in relation to a vehicle tire depicted in broken lines;

FIG. 9 is an enlarged view of a segment of the traction member taken along line 9-9 of FIG. 10;

FIG. 10 is a cross-sectional view taken along the line 10-10 of FIG. 2;

FIG. 11 is a perspective view of a tool component utilized to pull a traction member toward another traction member to facilitate final assembly and installation of the traction apparatus on a land vehicle;

FIG. 12 is a perspective view illustrating positioning of the tool component of FIG. 11 relative to a traction member prior to utilizing the tool component to pull the traction member toward opposing traction members of the traction apparatus;

FIG. 13 shows the tool component in place on a traction member and operatively engaged by a tightening belt of a come along-type ratchet device; and

FIG. 14 is a side, elevational view illustrating two tool components in place and in association with a ratchet-type come along device during the process of installation of the traction apparatus on land vehicle front and rear tires.

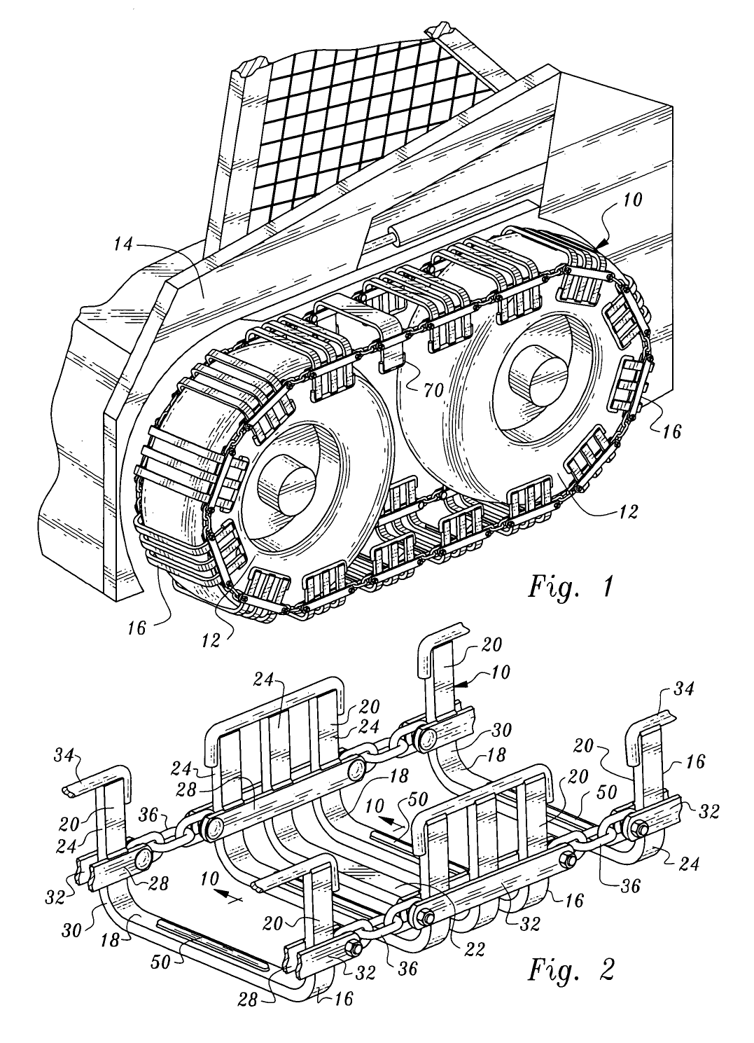

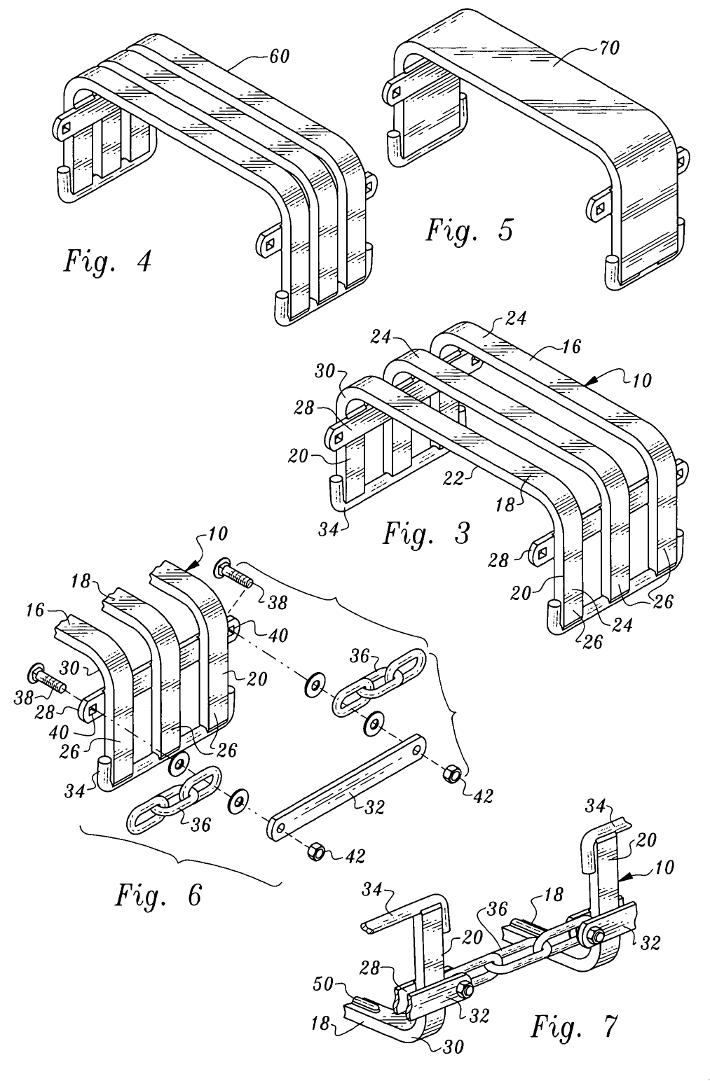

### BEST MODE FOR CARRYING OUT THE INVENTION

Referring now to the drawings, traction apparatus constructed in accordance with the teachings of the present invention is designated by reference numeral 10. FIG. 1 shows the apparatus 10 mounted on the front and rear tires 12 of a land vehicle 14 which may, for example, be a skid steer loader. It will be appreciated that traction apparatus 10 of like construction is disposed about the tires (not shown) on the other side of the vehicle.

Traction apparatus 10 when extending between the front and rear tire forms an endless track having an upper track portion and a lower track portion interconnected by end track portions engaging and partially surrounding the front and rear tires.

The traction apparatus 10 includes a plurality of rigid traction members 16, each including a traction member base 18 and spaced traction member sides 20 extending outwardly from spaced locations on the traction member base to form a generally U-shaped configuration and define a tire receiving recess 22. The illustrated traction members 16 are comprised of a plurality of spaced, generally U-shaped traction member bars 24, three such traction member bars being employed in each traction member 16. The traction member sides include three side legs 26 rigidly secured together by interior connector bars 28 welded to the side legs closely adjacent to smoothly curved bend 30 at the juncture of the base and sides. The base 18 includes three separate and spaced base segments, a pair of said traction side legs integrally attached to each base segment.

Each traction member side also includes a second connector bar 32 disposed outside of the side legs 26. An elongated stabilizer element in the form of bent rod 34 is welded to the distal ends of the side legs 26 to add to the structural strength and stability of the traction member and for other purposes such as prevention of damage to the tire sidewall as described below.

Connectors extend between and flexibly interconnect adjacent traction members. More particularly, the connectors include multi-link chains 36 extending between and flexibly interconnecting adjacent traction members 16. A pair of multi-link chains 36 extends between the adjacent traction members with the multi-link chains connected to the traction member sides 20.

The ends of each pair of connector bars 28, 32 are spaced from one another, the endmost links of the multi-link chains 36 being positioned in that space. The interiors of the endmost links are located between aligned openings at the ends of the connector bars of each pair.

Mechanical fasteners attach the multi-link chains to the connector bars. More particularly, the mechanical fasteners are in the form of carriage bolts 38, the shafts of which pass through the aligned openings of each pair of connector bars and through the endmost link positioned between the ends of the connector bars. The openings 40 in the fixed connector bars 28 conform to the shape of the carriage bolt shafts closely adjacent to the rounded heads thereof.

FIG. 6 illustrates the relationship between the various connector components and it will be seen that the carriage bolts not only serve to connect the multi-link chains 36 to the traction members, but also maintain connector bars 32 in place on the side legs 26. Securement is accomplished by threading nuts 42 into threaded engagement with the carriage bolts. Thus, an individual traction member may readily be connected to or disconnected from the rest of the traction apparatus for repair, adjustment, replacement, etc. The operator may, if desired, remove a plurality of interconnected traction members at a time. The arrangement disclosed herein is relatively lightweight compared to prior art devices, enabling an individual to accomplish this task.

FIG. 6 discloses the use of washers between the multi-link chains and the spaced connector bars. The chain links are freely rotatable about the carriage bolts. Locking of the carriage bolts against rotation within openings 40 of connector bars 28 allows one to readily disconnect the nuts from the bolts from outside the traction member.

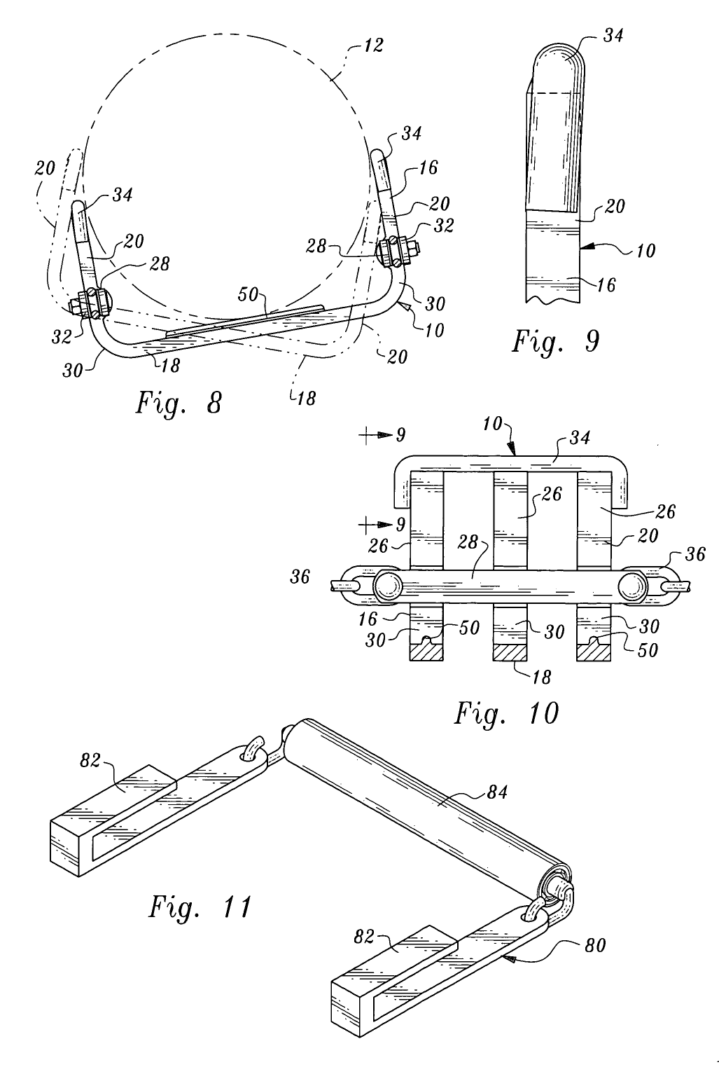

When practicing the teachings of the present invention, it has been found that the multi-link chains preferably comprise at least three links. This enables the adjacent traction members to freely pivot relative to one another in a plurality of planes, including but not limited to, pivotal movement in a plane occupied by the primary axis of the traction apparatus and a plane orthogonal thereto to adapt to different terrains and conditions and for ease of installation. FIG. 8 depicts tilting or pivoting of a traction member 16 in the orthogonal plane. Such action, of course, is not found in prior art arrangements wherein continuous chains extending the full length of the track are utilized to secure together the traction members or feet thereof or where non-flexible links are employed.

To increase traction between the tires and the traction members 16, tire engagement projection strips 50 extend upwardly from the traction member base between the traction member sides. In the arrangement illustrated there are two such projections 50 employed with each traction member, the projections being located at the outermost traction member bars 24.

The traction member sides are spaced so that they are disposed on opposed sides of the front and rear tires and in close proximity thereto. The distal ends of the traction member sides which comprise the bent rod 34 are angled inwardly toward one another, as perhaps may best be seen with reference to FIGS. 8 and 9. The bent rods 34 have smoothly curved tire engagement surfaces to minimize wear between the traction member sides and the tires.

FIG. 4 illustrates an alternative embodiment of traction member 60 which is essentially of the same construction as traction members 16 except that it is narrower.

FIG. 5 shows another embodiment of the traction member, traction member 70, which is narrower still and is formed from a single bent U-shaped traction member bar. FIG. 1 shows a single traction member 70 utilized in conjunction with a plurality of traction member 16 to form the endless track.

If desired, traction members 60 or 70 or others of various sizes and/or shapes can be utilized to replace one or more of the traction members 16 in the traction apparatus to provide for adjustment of the overall track length, for example to tailor the length to different vehicle or tire types or sizes, or because component wear. It may also be, for example, that the length of the traction apparatus is too long for a particular application if all traction members are the width of traction member 16.

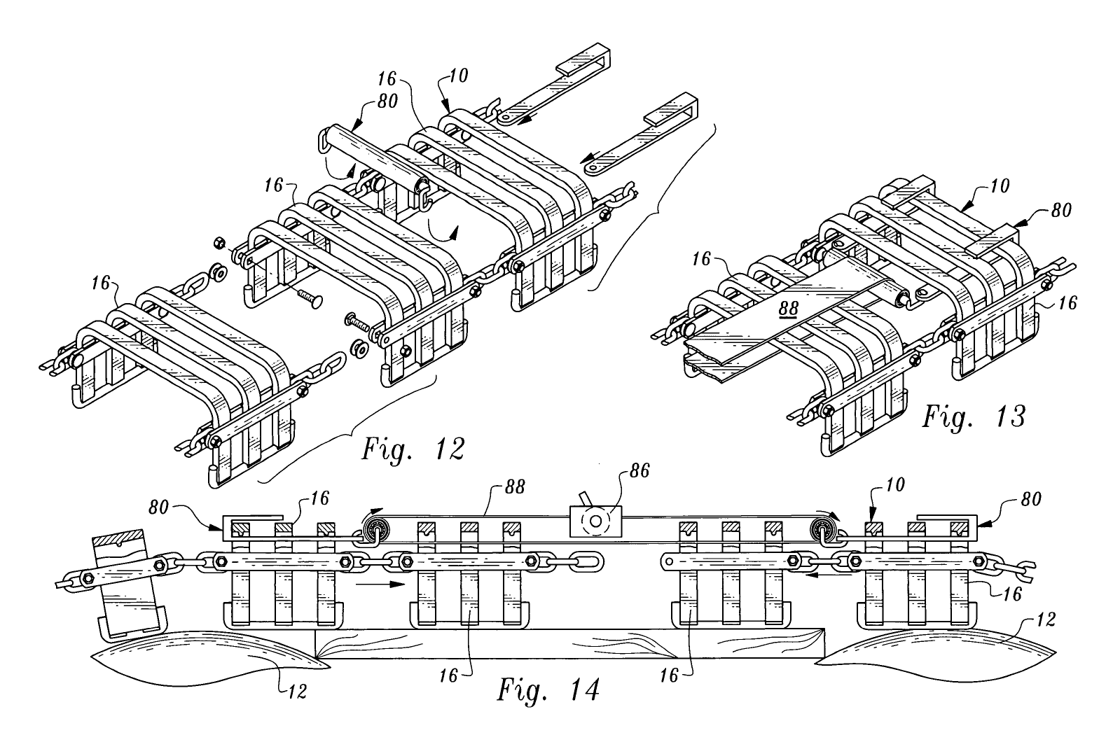

Referring now to FIGS. 11-14, a tool is disclosed for engaging spaced track members of the traction apparatus to pull them toward one another to finalize installation of the traction apparatus on the tires of a vehicle. The tool includes two traction member engagement devices 80. FIG. 11 shows one of the devices 80, consisting of two generally U-shaped brackets 82 connected to a rotatable roller 84. More particularly, the roller 84 rotates about a non-rotatable shaft 90 having hook-like ends 92. The roller and brackets are readily separable as shown in FIG. 12 so that one side of a traction member 16 is captured by recesses of the brackets and the roller disposed at the opposite side. In operation, the traction member engagement device 80 is assembled, as shown in FIG. 13.

FIG. 14 shows a second traction member engagement device 80 oriented 180 degrees from the first traction member engagement device indicated above and positioned on the other side of a gap existing in the upper track portion. A ratchet operated come along device 86 of any suitable conventional nature and including a belt 88 is connected to the rollers 84 of the two traction member engagement devices 80, the belt passing around the rollers as shown in FIG. 14. Operation of the ratchet come along device will cause the distal ends of the open track to be pulled together so that the operator can connect them with the connector components previously described. Rotation of the rollers of the tools, as shown by arrows in FIG. 14, reduces friction, contributing to ease of operation.

1. Traction apparatus extendable between front and rear tires of a land vehicle to improve traction of the land vehicle, said traction apparatus when extending between the front and rear tires forming an endless track having an upper track portion and a lower track portion interconnected by end track portions engaging and partially surrounding said front and rear tires, said traction apparatus comprising, in combination:
a plurality of rigid traction members, adjacent traction members of said plurality of rigid traction members each including a traction member base and spaced traction member sides extending outwardly from spaced locations on said traction member base to form a generally U-shaped configuration and define a tire receiving recess; and
connectors including multi-link chains extending between and flexibly interconnecting said adjacent traction members.

2. The traction apparatus according to claim 1 wherein a pair of multi-link chains extends between said adjacent traction members.

3. The traction apparatus according to claim 2 wherein the multi-link chains of each said pair of multi-link chains extend between and are connected to the spaced traction member sides of said adjacent traction members.

4. The traction apparatus according to claim 1 wherein said traction member sides include connector bars defining openings, said connectors additionally including mechanical fasteners attaching said multi-link chains to said connector bars.

5. The traction apparatus according to claim 4 wherein said traction member sides additionally include side legs, a pair of said connector bars being attached to each traction member side leg, said mechanical fastener including a connector shaft passing through the openings of both connector bars of each pair of connector bars.

6. The traction apparatus according to claim 5 wherein the connector bars of each pair of connector bars are spaced from one another, the connector shaft passing through openings thereof also passing through a link of one of said multi-link chains being positioned between the connector bars of each pair of connector bars.

7. The traction apparatus according to claim 6 wherein one of the connector bars of each pair of connector bars is rigidly permanently attached to its associated traction member side leg and wherein the other connector bar thereof is selectively releasably connected to its associated traction member side leg to facilitate selective attachment or detachment of the associated multi-link chain.

8. The traction apparatus according to claim 6 wherein said connector shaft is a carriage bolt shaft.

9. The traction apparatus according to claim 1 wherein the traction member base and spaced traction member sides of at least some of said rigid traction members comprise a plurality of spaced, generally U-shaped traction member bars, said traction member sides including side legs and connector bars rigidly securing together said traction member bars at said traction member side legs.

10. The traction apparatus according to claim 1 having a primary axis and wherein each said multi-link chain comprises at least three links, said adjacent traction members being free to pivot relative to one another in a plurality of planes, including but not limited to, pivotal movement in a plane occupied by said primary axis and a plane orthogonal thereto to adapt to different terrains and conditions.

11. The traction apparatus according to claim 1 wherein said spaced traction member sides are spaced so that they will be disposed on opposed sides of said front and rear tires and in close proximity thereto, said spaced traction member sides of each traction member having distal ends angled inwardly toward one another.

12. The traction apparatus according to claim 11 wherein said distal ends have smoothly curved tire engagement surfaces.

13. The traction apparatus according to claim 9 wherein said traction member base includes separate base segments, a pair of said traction member side legs integrally attached to each base segment and joining at smoothly curved bends, said connector bars located closely adjacent to said bends on said traction member side legs.

14. The traction apparatus according to claim 6 wherein the connector bars of each pair of connector bars are spaced apart a distance greater than the thickness of the link positioned therebetween whereby rotation thereof about said connector shaft is unimpeded by said connector bars.

15. The traction apparatus according to claim 7 wherein the connector bar rigidly, permanently attached to its associated traction member side leg is welded thereto.

16. The traction apparatus according to claim 1 wherein said multi-link chains are disposed between all adjacent traction members of said traction apparatus and wherein said multi-link chains comprise the only connector structure extending completely between adjacent traction members.

17. The traction apparatus according to claim 8 wherein at least one of said openings is shaped to conform to the shape of the carriage bolt shaft at said at least one opening to prevent rotational movement of said carriage bolt.

18. The traction apparatus according to claim 17 wherein said carriage bolt has a rounded head extending inwardly into said tire receiving recess.

19. The traction apparatus according to claim 1 additionally comprising a tool selectively operatively engageable with spaced traction members to pull said spaced traction members toward one another to change the length of at least one of said track portions.

20. The traction apparatus according to claim 1 additionally comprising at least one tire engagement projection projecting from said traction member base into said tire receiving recess for engagement with a vehicle tire to reduce slippage between the tire and said traction apparatus.

21. The traction apparatus according to claim 9 wherein said traction member side legs have distal ends and wherein each said traction member additionally comprises an elongated stabilizer element extending between and rigidly interconnecting said distal ends.

22. A tool operatively engageable with a traction member of a flexible track belt to pull the traction member to facilitate installation of the track belt, said tool comprising in combination:
a shaft having two opposed shaft ends;
a roller rotatably mounted on said shaft between said ends; and
brackets releasably connected to said shaft ends and defining bracket recesses for receiving the traction member, said roller engageable and rotatable by the belt of a come along device.

23. Traction apparatus extendable around a tire of a land vehicle to improve traction of the land vehicle, said traction apparatus forming an endless track comprising, in combination:
a plurality of rigid traction members, adjacent traction members of said plurality of rigid traction members each including a traction member base and spaced traction member sides extending outwardly from spaced locations on said traction member base to form a generally U-shaped configuration and define a tire receiving recess; and
connectors including multi-link chains extending between and flexibly interconnecting said adjacent traction member.
